(19) United States
(12) Patent Application Publication
(10) Pub. No.: US 2019/0061949 A1
(43) Pub. Date: Feb. 28, 2019

(54) EMERGENCY EQUIPMENT FOR AN AIRCRAFT COMPRISING A RESPIRATORY MASK

(71) Applicant: Zodiac Aerotechnics, Plaisir (FR)

(72) Inventors: Olivier Potet, Palaiseau (FR); Benoît Bouchet, Plaisir (FR); Frédéric Berthet, Plaisir (FR)

(73) Assignee: Zodiac Aerotechnics, Plaisir (FR)

(21) Appl. No.: 15/756,957

(22) PCT Filed: Sep. 29, 2015
(86) PCT No.: PCT/IB2015/001975

§ 371 Date: Mar. 1, 2018

(51) Int. Cl. B64D 11/00; A62B 7/14; A62B 25/00

(52) U.S. Cl. CPC B64D 11/00; B64D 2231/025; A62B 25/005; A62B 7/14

(57) ABSTRACT

An emergency equipment for an aircraft comprising: —a respiratory mask (5) comprising a harness (6), the respiratory mask (5) being adapted to be applied in a use position around the nose and the mouth of a user, —a stowage box (1) comprising a housing, the housing having side walls (2), a back wall (3) and an opening (4) opposite to the back wall (3), the side walls (2) and the back wall (3) defining an internal space (32) adapted to stow the respiratory mask (5) in a stowage position. The emergency equipment further comprises a support (10) supporting the respiratory mask (5) in the stowage position. The support (10) comprises a main plate (11) which is rigid and which is movable with respect to the stowage box (1) between a backward position and a frontward position along a longitudinal direction. The support (10) is in the backward position in the stowage position of the respiratory mask (5).

### FIELD OF THE DISCLOSURE

The present invention relates to an emergency equipment to be used in an aircraft in particular by a crewmember.

### BACKGROUND OF THE DISCLOSURE

Emergency equipments for aircraft comprising a respiratory mask and a stowage box are well known. The respiratory mask comprises an oronasal face piece and a harness. The oronasal face piece is intended to be applied on the face of the user in a use position to provide oxygen enriched respiratory gas. The harness enables to maintain the oronasal face piece on the face of the user. The respiratory mask may comprise a separate eye protective shield (goggles) or an eye protective shield integral with the oronasal face piece. The eye protective shield provides protection in particular against smoke and can also support a display device.

The emergency equipments are placed in the cabin of an aircraft, in particular in the cabin of a commercial aircraft (not fighter aircraft), more particularly in the cockpit to be used by the pilot. Crewmembers, and usually also passengers, are within the cabin. The cabin is pressurised for enabling the passengers and the pilots to normally breathe within the cabin.

The respiratory mask is stowed in the stowage box in a stowage position. In case of depressurisation, due a to a failure of the pressurising device, a hole through which the cabin air leaks, or the like, the user of the emergency equipment, usually a pilot, grasps the respiratory mask, brings it out of the stowage box through an opening and places the respiratory mask on the face in a use position with only one hand.

Such a stowage box is important for protecting the respiratory mask and it satisfies the need for having a location for stowing the respiratory mask in a predefined position, so as to ensure that the aircraft crewmember may quickly apply the respiratory on his face.

That is the reason why the stowage boxes are sometimes placed into the instrument panel of the aircraft cockpit, within arm's reach, near the pilots. The stowage device may be in front or on one side of the pilot.

When an oxygen deficiency is detected, the pilot has got less than 5 seconds to grasp the emergency mask and to apply it on his face. So, it is important that the respiratory mask can be easily brought out of the stowage box and the harness quickly inflates.

But, the cockpit of the aircrafts has usually a dedicated place for mounting such stowage devices. Because of all the other equipments which have also to be within arm's reach of the pilot, such a dedicated place is limited and the stowage device have to respect some dimensional features. Therefore, the size of the opening cannot be increased.

An object of the invention is to provide emergency equipment wherein the respiratory mask can be easily brought out of the stowage box, because it is not allowed, for safety reasons, that one part of the emergency equipment remains jammed when the pilot catches the respiratory mask for applying it on his face.

Another object of the invention is to ease the stowage of the respiratory mask in the stowage box.

### SUMMARY OF THE DISCLOSURE

To this end, the invention relates to an emergency equipment for an aircraft comprising:
a respiratory mask comprising a harness, the respiratory mask being adapted to be applied in a use position around the nose and the mouth of a user,
a stowage box comprising a housing, the housing having side walls, a back wall and an opening opposite to the back wall, the side walls and the back wall defining an internal space adapted to stow the respiratory mask in a stowage position, wherein:
   the emergency equipment further comprises a support supporting said respiratory mask in the stowage position,
   the support comprises a main plate which is rigid and which is movable with respect to the stowage box between a backward position and a frontward position along a longitudinal direction, the support being in the backward position when the respiratory mask is in the stowage position.

Thanks to these features, the main plate which is movable with respect to the housing helps the user to place the respiratory mask into the housing, by placing the respiratory mask on the support and moving the support from the frontward position to the backward position.

Furthermore, the main panel acts as a protective element for the respiratory mask, isolating the respiratory mask from at least one of the internal faces of the housing against which the respiratory mask (and more particularly the harness) can press when it is placed into the housing.

The main plate can also comprise features in order to position each part of the respiratory mask onto the main plate, helping the user to correctly place the respiratory mask into the housing of the stowage device.

The stowage device according to the invention could also comprise one or several of the following features:
between the backward position and the frontward position, the rigid plate extends along the longitudinal direction between a back edge and a front edge, and the main plate extends along a width direction between a first longitudinal edge and a second longitudinal edge, the width direction being perpendicular to the longitudinal direction;
one of the side walls of the housing is a main wall, and said support is slidingly mounted on said main wall;
said main plate is mounted on said main wall through a slide rail protruding from said main wall;
the main wall of the housing has an internal face, the main plate of the support has a first face and a second face opposite the first face, in the stowage position the first face supporting the respiratory mask and the second face facing the internal face of the main wall;
the main plate has a recess provided in the second face and said recess receives the slide rail, the main plate has a substantially constant thickness so that the first face of the rigid portion has a rib corresponding to said recess and extending along the longitudinal direction in the stowage position, and the recess of the main plate is substantially at equal distance from the first longitudinal edge and the second longitudinal edge;
the support further comprises a first lateral plate which extends perpendicularly to the width direction along the first longitudinal edge of the main plate and a second lateral plate which extends perpendicularly to the width direction along the second edge of the main plate;
the support further comprises a back plate, which is parallel to the back wall of the housing and within the housing of the stowage box when the support is in the backward position;
said support is movable with respect to the stowage box between the frontward position and a rotated position by rotation around a rotation axis which is substantially parallel to the width direction;
In the rotated position, the rotation axis is close to the opening of the housing of the stowage box;
the main plate comprises a stud on which the respiratory mask is placed in the stowage position.

### BRIEF DESCRIPTION OF THE DRAWINGS

The invention will be better understood with the help of the drawings, in which:

FIG. 1 is a lateral view of an emergency equipment according to a first embodiment of the invention, in a stowage position, a respiratory mask being placed properly on a support, the support being placed in a backward position properly inside a housing of a stowage box;

FIG. 2 is a perspective view of the emergency equipment without the respiratory mask, in a rotated position of the support,

FIG. 3 is a front view of the emergency equipment without the respiratory mask, the support being placed in the backward position,

FIG. 4 is a lateral view of the emergency equipment substantially in a use position, illustrating the respiratory mask extracted from the housing of the stowage box, the support of the emergency equipment being in the backward position,

FIG. 5 is a lateral view of the emergency equipment, illustrating the respiratory mask outside the housing of stowage box and the support of the respiratory mask outside the housing of stowage box, in the rotated position,

FIG. 6 is a lateral view of the stowage box, illustrating the respiratory mask placed properly on the support, the support entering into the housing of the stowage box by moving from the frontward position to the backward position, and

FIG. 7 is a front view of an emergency equipment according to a second embodiment of the invention.

### DETAILED DESCRIPTION

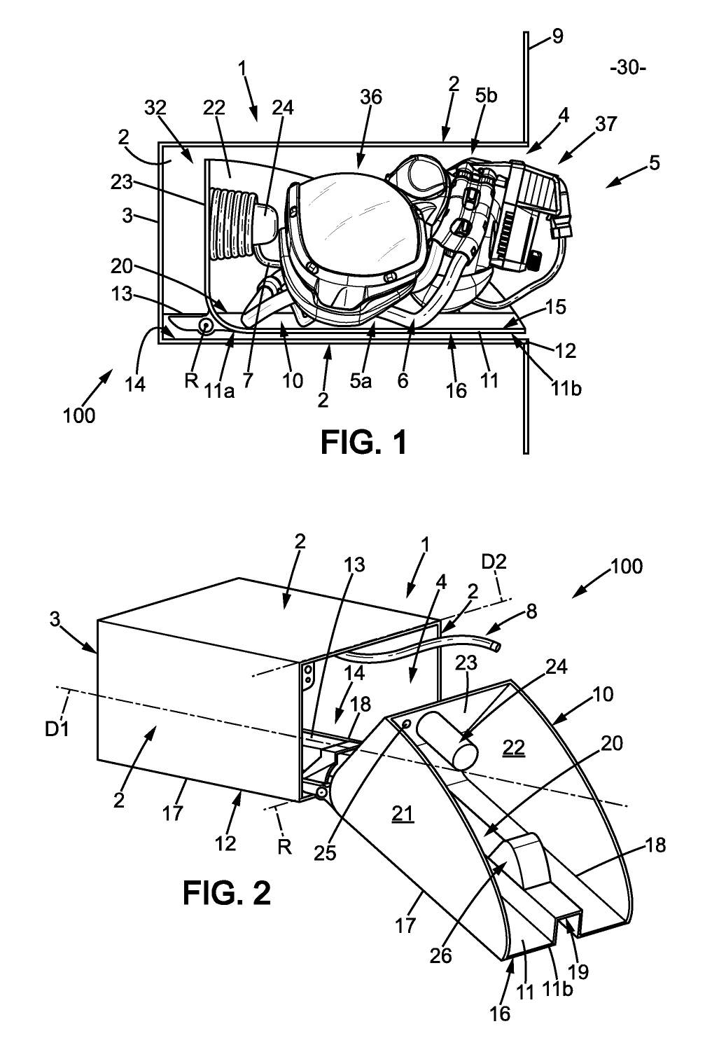

FIGS. 1 to 6 show a first embodiment of an emergency equipment 100 according to the invention, the emergency equipment 100 being in a cabin 30 of an aircraft, in particular in the cockpit of the aircraft. The emergency equipment 100 comprises a respiratory mask 5, a stowage box 1 and a support 10.

The stowage box 1 stows the respiratory mask 5 in a stowage position of the emergency equipment 100 shown in FIG. 1.

The stowage box 1 comprises a housing having four side walls 2 forming a rectangular cross sectional tube (see more particularly FIG. 2) extending along a longitudinal direction D1, a back wall 3 closing one end of the rectangular cross sectional tube and an opening 4, opposite to the back wall 3, at the other end of the tube.

The housing comprises an internal space 32, delimited by the side walls 2 and the back wall 3. In a stowage position of the emergency equipment 100, the respiratory mask 5 is stowed in the internal space 32 (see FIGS. 1 and 4 to 6).

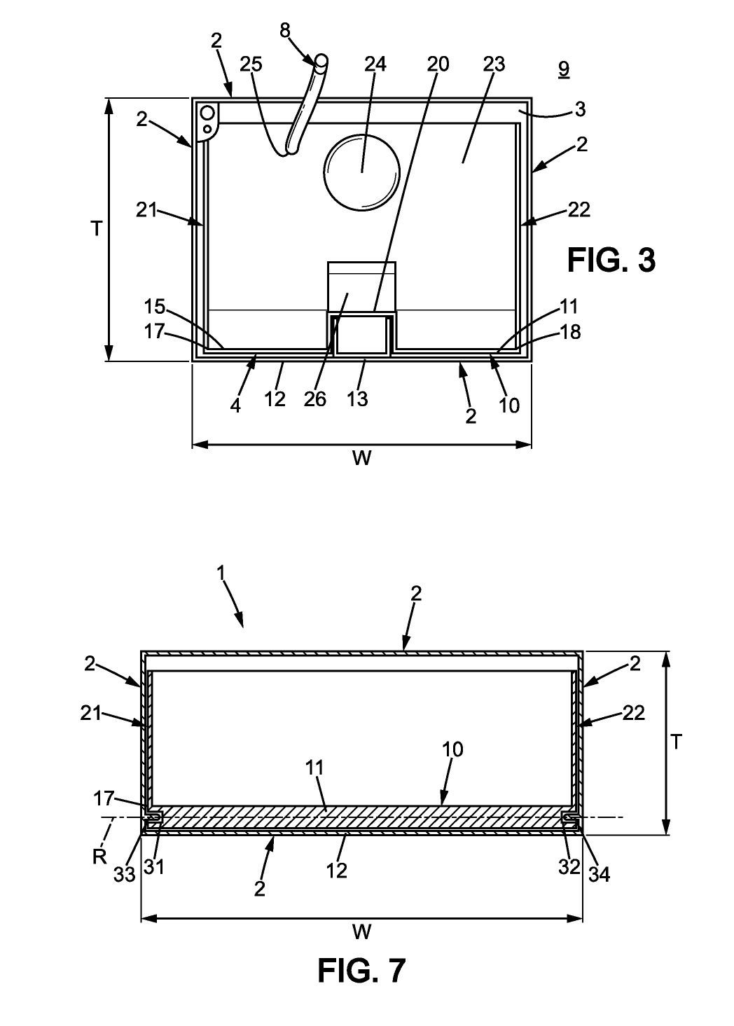

In the embodiment shown, the emergency equipment 100 is inserted through a passage in an instrument panel 9. It has to be noted that the shape and the external section (perpendicularly to the longitudinal direction D1) of the housing of the stowage box is normalized. The section is rectangular and there are two sizes: either 14.6 cm (5.75 inches) of width W along a width direction D2 and 11.43 cm (4.5 inches) of height along a transversal direction D3 or 20 cm (7.87 inches) along the width direction D2 and 12.19 cm (4.8 inches) along the transversal direction D3 (see FIGS. 3 and 7).

The width direction D2 is perpendicular to the longitudinal direction D1 and the transversal direction D3 is perpendicular to the longitudinal direction D1 and to the width direction D2. In the embodiment shown, the transversal direction D3 extends substantially vertically. In an alternative embodiment, the longitudinal direction D1 may extend substantially vertically, the back wall 3 being in contact with the floor of the cabin 30.

The respiratory mask 5 comprises a rigid grasping portion 37, an oronasal face piece 35 and a harness 6 for applying and maintaining the oronasal face piece 35 around the nose and the mouth of a user. The respiratory mask 5 further comprises an optional eye protective shield 36. The respiratory mask 5 has a back face 5a and a front face 5b opposite the back face 5a. The back face 5a is intended to be in contact with a user face in the use position.

The respiratory mask 5 is also linked to a supply tube 7, for supplying oxygen from an oxygen source (not shown). FIGS. 2 and 3 show a linking tube 8, to which the supplying tube 7 can be linked in order to be connected to the oxygen source.

The support 10 comprises a plate 11, which is rigid and which is mounted on one of the side walls 2 of the housing in such a manner that the rigid plate 11 can slide along the side wall 2. Such a side wall 2 will be named “main wall” of the housing, and is referenced 12 on FIGS. 1 to 7.

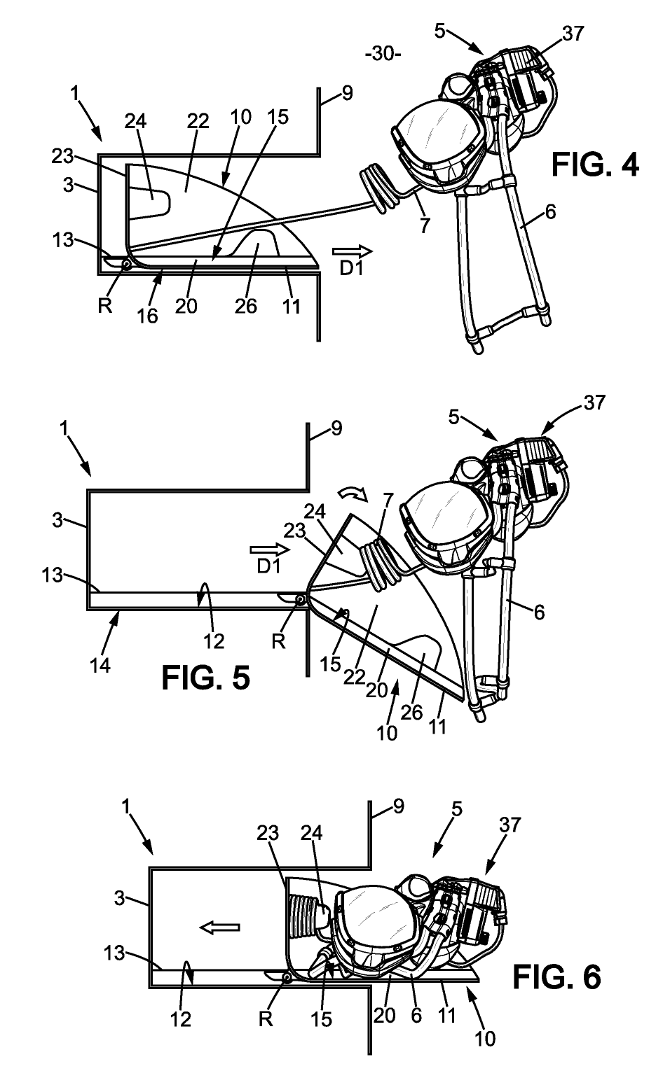

The sliding movement of the rigid plate 11 allows the support 10 to move between two positions:
a backward position, shown in FIGS. 1 and 4, wherein the support 10 wholly extends within the internal space 32,
and a frontward position wherein the support 10 extends at least partially outside the internal space 32, along the longitudinal direction D1 (see FIGS. 2 and 5).

For allowing the sliding movement of the rigid support plate 11 with respect to the stowage box 1, the plate 11 is mounted on the main wall 12 through a slide rail 13 protruding from said main wall.

The slide rail 13 is of a common type and comprises for example a first profile secured to the main wall 12, a second profile secured to the support plate 11 and balls running between the first profile and the second profile. The slide rail 13 is provided onto the internal face 14 of the main wall 12 and extends along a symmetrical axis in the longitudinal direction D1 of the main wall 12 (see FIG. 2).

The support 10 slides between the backward position and the frontward position longitudinal direction D1.

Furthermore, the rigid plate 11 extends along the width direction D2 between a first longitudinal edge 17 and a second longitudinal edge 18.

The rigid plate 11 comprises a first face 15, supporting the respiratory mask 5 when the respiratory mask is stowed into the housing. The rigid plate 11 also comprises a second face 16, opposite to the first face 15, the second face 16 facing the internal face 14 of the main wall 12 when the support is in the backward position (see FIG. 1).

FIG. 2 shows that the rigid plate 11 comprises, along the longitudinal direction D1 at a medium plane, a recess 19 which receives the slide rail 13. The recess 19 is provided substantially at equal distance from the first longitudinal edge 17 and the second longitudinal edge 18.

The recess 19 is provided in the second face 16 of the rigid plate 11 and the rigid plate has a substantially constant thickness, so the rigid plate has a protruding portion forming a rib 20, extending along the longitudinal direction D1, on the first face 15. The rib 20 corresponds to said recess 19 and protrudes from the first face 15.

In the stowage position the respiratory mask 5 is supported by the main plate 11, the back face 5a of the respiratory mask facing the first face 15 of the rigid plate 11. The rib 20 leads to a way for placing the respiratory mask onto the rigid plate 11: as the back face 5a of the respiratory mask has a generally curved concave shape, in the stowage position, the respiratory mask 5 is sitting astride the rib 20, so that the rib 20 has no substantial detrimental effect on the position of the respiratory mask along the transversal direction D3.

The support 10 further has a stud 26, helping to place the respiratory mask 5 on the support 10 at the right place. The protruding element 26 has a shape which is high enough for substantially maintaining the respiratory mask 5, and little enough for allowing to easily bring the respiratory mask 5 out of the internal space 32 from the stowage position in which the respiratory mash is placed into the housing on the rigid plate 11 of the support 10, the support being in the backward position. In the embodiment shown in FIGS. 1 to 6, the stud 26 is fixed at the top of the rib 20, but in other embodiments of the invention the support 10 could be provided with a stud 26 but without rib 20.

As shown in FIGS. 2 and 3, the support 10 comprises a first lateral plate 21 which extends perpendicularly to the width direction D2 at the first edge 17 of the rigid plate 11, and a second lateral plate 22 which extends perpendicularly to the width direction at the second edge 18 of the rigid plate 11.

For understanding reasons, only the second lateral plate 22 has been represented in FIG. 1, in order to see the mask 5 stowed into the stowage box 1.

The support 10 also comprises a back plate 23, which is parallel to the back wall 3 of the housing of the stowage box 1 in the backward position of the support 10. The back plate 23 forms a U shape with the first and second lateral plates 21 and 22 of the housing.

Thus, lateral plates 21, 22 and the back plate 23 form peripheral parts of the support 10 which are placed between the respiratory mask 5 and the internal faces of the side walls of the housing and prevent the respiratory mask 5 from friction against the internal faces of the housing when the support 10 slides between the backward position and the frontward position.

The better the respiratory mask 5 is arranged into the housing, the easier the extraction of the respiratory mask is because friction is avoided. Then, all the elements placed into the housing, onto the support 10, have to be disposed in a specific place to ease bringing the respiratory mask 5 out of the stowage box 1. That is the reason why the back plate 23 is provided with a pin 24 around which the supplying tube 7 can be rolled up.

The back plate 23 also comprises a hole 25, and the linking tube 8 can be connected to the supply tube through the hole 25.

FIGS. 4 to 5 shows several steps during which the respiratory mask 5 is extracted and during which the respiratory mask 5 is put back into the stowage box 1.

FIG. 1 shows the respiratory mask 5 placed into the housing, in the stowage position, before a user grasps the grasping portion 37 of the respiratory mask 5.

FIG. 4 shows a first step to move the respiratory mask 5 donned on the face of the user, in a use position of the emergency equipment. As shown in FIG. 4, the respiratory mask 5 is grasped by a user and then brought out of the stowage box 1 while the support 10 stays in the backward position in the stowage box.

However, it is possible that the support 10 exits partially or totally from the stowage box 1 when the respiratory mask is grasped and extracted. It is also possible to provide the emergency equipment with a spring or the like urging the support 10 toward the backward position, into the housing of the stowage box 1.

FIG. 5 shows a step for placing the respiratory mask 5 and the supplying tube 7 in the stowage position: the pulls the support 10 out of the housing, thus moving the support 10 from the backward position (FIG. 4) to the frontward position (FIG. 5) by sliding the rigid plate 11 on the rail 13.

In the forward position, the outward movement of the support 10 is stopped by abutment, but as the support 10 is rotatably mounted on the slide rail 13, the support may be moved in a rotated position by rotation around a rotation axis R which is substantially parallel to the width direction D2, and close to the opening 4 of the housing (see also FIG. 2). In the rotated position of the support 10, it is easier to place the respiratory mask 5 and the supplying tube 7.

Firstly, for placing the respiratory mask 5 on the support 10, the supplying tube 7 is rolled around the protruding element 24 on the back plate 23, and secondly the respiratory mask 5 is placed on the rigid plate and in particular the oronasal face piece 35 is placed on the stud 26, which protrudes from the rigid plate 11.

After having placed correctly the respiratory mask 5 and the tube 7, the support 10 is rotated around the rotation axis R up to the frontward position and then slided into the housing, from the frontward position to the backward position—see FIG. 6. During the movement of the support from the rotated position to the backward position, the respiratory mask 5 is not moved with respect to the support 11.

FIG. 1 shows the respiratory mask 5 in the stowage position, with the support 10 in the backward position into the housing.

Other technical devices can be used in order to slide the rigid plate 11 into the housing.

FIG. 7 shows a second embodiment—But it must be understood that the invention is not limited to the embodiments shown in figures and that other technical means could be used than the shown technical means without being out of the field of the invention.

FIG. 7 shows schematically the support 10 according to the invention, comprising a rigid plate 11, placed into the housing of a stowage box 1.

The rigid plate 11 comprises, along each of its longitudinal edges 17 and 18, a groove (respectively 31 and 32). Furthermore, in the embodiment shown, each lateral plate 21 and 22 of the housing comprises a sliding element 33 and 34 (respectively) proximate the opening 4, the sliding elements being formed by pins in the embodiment shown, each sliding element 33 and 34 sliding in the respective groove 31 and 32 when the support 10 slides between the backward position and the frontward position.

When the support 10 is in the frontward position, the support 10 is substantially outside the housing and is able to rotate from the frontward position to the rotated position about the rotation axis R extending along the pins forming sliding element 33 and 34.

Of course the invention is not limited to the embodiments illustrated for illustrative and not limitative purpose. For example, the opening may be substantially closed by one or two doors in the stowage position.

1. Emergency equipment for an aircraft comprising:
a respiratory mask comprising a harness, the respiratory mask being adapted to be applied in a use position around the nose and the mouth of a user,
a stowage box comprising a housing, the housing having side walls, a back wall and an opening opposite to the back wall, the side walls and the back wall defining an internal space adapted to stow the respiratory mask in a stowage position, wherein:
the emergency equipment further comprises a support supporting said respiratory mask in the stowage position,
the support comprises a main plate which is rigid and which is movable with respect to the stowage box between a backward position and a frontward position along a longitudinal direction, the support being in the backward position when the respiratory mask is in the stowage position.

2. The emergency equipment according to claim 1, wherein:
between the backward position and the frontward position, the rigid plate extends along the longitudinal direction between a back edge and a front edge, and
the main plate extends along a width direction between a first longitudinal edge and a second longitudinal edge, the width direction being perpendicular to the longitudinal direction.

3. The emergency equipment according to claim 2, wherein:
one of the side walls of the housing is a main wall, and
said support is slidingly mounted on said main wall.

4. The emergency equipment according to claim 3, wherein
said main plate is mounted on said main wall through a slide rail protruding from said main wall.

5. The emergency equipment according to claim 4, wherein:
the main wall of the housing has an internal face, and
the main plate of the support has a first face and a second face opposite the first face, in the stowage position the first face supporting the respiratory mask and the second face facing the internal face of the main wall.

6. The emergency equipment according to claim 5, wherein
the main plate has a recess provided in the second face and said recess receives the slide rail,
the main plate has a substantially constant thickness so that the first face of the rigid portion has a rib corresponding to said recess and extending along the longitudinal direction in the stowage position, and
the recess of the main plate is substantially at equal distance from the first longitudinal edge and the second longitudinal edge.

7. The emergency equipment according to claim 2, wherein the support further comprises a first lateral plate which extends perpendicularly to the width direction along the first longitudinal edge of the main plate and a second lateral plate which extends perpendicularly to the width direction along the second edge of the main plate.

8. The emergency equipment according to claim 7, wherein the support further comprises a back plate, which is parallel to the back wall of the housing and within the housing of the stowage box when the support is in the backward position.

9. The emergency equipment according to claim 2, wherein said support is movable with respect to the stowage box between the frontward position and a rotated position by rotation around a rotation axis which is substantially parallel to the width direction.

10. The emergency equipment according to claim 9, wherein, in the rotated position, the rotation axis is close to the opening of the housing of the stowage box.

11. The emergency equipment according to any one of the preceding claim 1, wherein the main plate comprises a stud on which the respiratory mask is placed in the stowage position.
